(19) United States
(12) Patent Application Publication
(10) Pub. No.: US 2026/0096502 A1
(43) Pub. Date: Apr. 9, 2026

(54) HIGH-SPEED SEEDING SYSTEM

(71) Applicant: Xinjiang Academy of Agricultural and Reclamation Science, Shihezi City (CN)

(72) Inventors: Chao JI, Shihezi City (CN); Jincheng CHEN, Shihezi City (CN); Feng PAN, Shihezi City (CN); Baiwei WANG, Shihezi City (CN)

(21) Appl. No.: 19/250,989

(22) Filed: Jun. 26, 2025

(30) Foreign Application Priority Data
Oct. 8, 2024 (CN) 202411395883.0

(51) Int. Cl. A01C 7/00

(52) U.S. Cl. CPC A01C 7/002

(57) ABSTRACT

A high-speed seeding system is provided. The system includes a crawler mechanism, a seed metering mechanism, and multiple hill-drop devices. The crawler mechanism includes a motor drive unit, transmission crawler belts, and a crawler support unit. The transmission crawler belts are provided with hill-drop mounting holes at intervals. The motor drive unit is configured to drive the transmission crawler belts through the crawler support unit. The hill-drop devices are respectively mounted in the hill-drop mounting holes according to seeding intervals. The seed metering mechanism is fixed on the crawler support unit and is configured to deliver seeds to the hill-drop devices and push the hill-drop devices downward for seeding when the hill-drop devices pass underneath the seed metering mechanism.

### CROSS-REFERENCE TO RELATED APPLICATIONS

This application claims priority to Chinese Patent Application No. 202411395883.0, filed on Oct. 8, 2024, the contents of which are hereby incorporated by reference.

### TECHNICAL FIELD

The disclosure relates to a seeding system, and in particular to a high-speed seeding system.

### BACKGROUND

At present, with the progress of seeding technology, precision seeding and precision hill dropping technology have been applied and popularized. However, in the seeding process of crops, the punching devices on the film are all roller-type or four-bar mechanism for punching and seeding. Due to the extremely short contact time between the sowing positions and the ground, it is difficult for seeds to effectively fall into the seed holes, which leads to the failure to effectively improve the working speed of the machines and tools. Moreover, it is also possible to pull the seeds out of the soil when the punching unit rolls away. In addition, due to the short time of seed operation, the seeds may jump and deviate from their positions when falling, reducing the precision of seed placement. Especially, the seeds may not fall into the holes in time during the punching on the film and seeding operation, leading to the problems of low speed and low efficiency. In severe cases, the seeds may fall onto or outside the film, causing missed seeding and affecting the quality of seeding.

### SUMMARY

The disclosure aims to provide a high-speed seeding system, which may accurately sow seeds into soils under the film and ensure the precision and reliability of sowing.

The technical solution of the disclosure is as follows. A high-speed seeding system includes a crawler mechanism, a seed metering mechanism, and multiple hill-drop devices, where the crawler mechanism includes a motor drive unit, transmission crawler belts, and a crawler support unit, where the transmission crawler belts are provided with multiple hill-drop mounting holes at intervals, the crawler support unit is configured to support and drive the transmission crawler belts, the motor drive unit is configured to drive the transmission crawler belts through the crawler support unit, the hill-drop devices are respectively mounted in the hill-drop mounting holes according to seeding intervals, and the seed metering mechanism is fixed on the crawler support unit and is configured to deliver seeds to the hill-drop devices and push the hill-drop devices downward for seeding when the hill-drop devices pass underneath the seed metering mechanism.

In some embodiments, the crawler support unit includes four support rollers, two roller shafts, and two strip-shaped support plates, where the motor drive unit includes a drive motor and a sprocket transmission assembly, where the two roller shafts are rotatably mounted between respective ends of the two strip-shaped support plates, the four support rollers are respectively fixed on ends of the two roller shafts, a clearance is formed between two of the support rollers on a same roller shaft for allowing passage of the hill-drop devices, the drive motor is fixed on the strip-shaped support plates and configured to drive one of the roller shafts to rotate through the sprocket transmission assembly, drive annular grooves are arranged on wheel surfaces of the support rollers, drive teeth are provided in the drive annular grooves, the transmission crawler belts are wound around the four support rollers, and driven teeth meshing with the drive teeth are provided on inner sides of the transmission crawler belts.

In some embodiments, the seed metering mechanism includes a support unit, a friction unit, a rotary drive disk, a seed metering disk, an outer housing, a suction unit, a blowing unit, and multiple seed-suction inserts, where a disk-shaped cavity is formed inside the seed metering disk, a support short shaft is fixed at a center of a rear disk surface of the seed metering disk, an end of the support short shaft is rotatably mounted on the support unit, the rotary drive disk is fixed on the support short shaft and is rotated by being pushed by the hill-drop devices passing underneath, the friction unit is mounted on the support unit and provides frictional damping to the rotary drive disk, multiple T-shaped slots are circumferentially arranged at intervals on an outer circumferential surface of the seed metering disk, the seed-suction inserts are respectively inserted into the T-shaped slots along a axial direction of the rotary drive disk, multiple seed-suction ventilation holes are arranged on the seed-suction inserts, outer openings of the seed-suction ventilation holes are configured as conical slopes, communication holes in communication with the seed-suction ventilation holes are provided on a wall of the disk-shaped cavity, the outer housing covers the outer circumferential surface of the seed metering disk and is fixed on the support unit, a seed storage bin is provided at a lower left side of the outer housing, a seed delivery pipe is connected to a top of the seed storage bin, a seed metering pipe is vertically arranged at a lower part of the outer housing for delivering the seeds to the hill-drop devices below, the blowing unit penetrates through a center of a front disk surface of the seed metering disk and blows air into the communication holes at a lowest position in the disk-shaped cavity to blow the seeds adsorbed on the seed-suction ventilation holes at the lowest position into the seed metering pipe, and the suction unit penetrates through the center of the front disk surface of the seed metering disk and is configured to suck air from the communication holes at other positions in the disk-shaped cavity to adsorb the seeds onto the seed-suction ventilation holes at the other positions.

In some embodiments, the friction unit includes a support sleeve, a support disk, a friction spring, and a friction plate, where one end of the support sleeve is fixed on the support unit, the support disk is axially slidably mounted on a cantilevered end of the support sleeve, the friction spring is sleeved on the support sleeve and elastically supports between the support unit and the support disk, the friction plate is fixed on the support disk and configured to presses against the rotary drive disk under support of the friction spring, the support short shaft penetrates through the friction plate, the support disk, and the support sleeve and is rotatably mounted on the support unit, a rotation-limiting chute is arranged on an outer wall of the support sleeve along a length direction of the support sleeve, and a rotation-limiting slider slidably embedded in the rotation-limiting chute is provided on the support disk.

In some embodiments, the suction unit includes a suction cover, a suction pipe, a penetration pipe, and a negative-pressure connection pipe, where one end of the penetration pipe is fixed on the support unit, another end rotatably penetrates through the center of the front disk surface of the seed metering disk, two ends of the penetration pipe are sealed, one end of the suction pipe is connected to an inner sealed end side of the penetration pipe, one end of the negative-pressure connection pipe is connected to an outer sealed end side of the penetration pipe, another end of the suction pipe is connected to the suction cover, another end of the negative-pressure connection pipe is connected to a negative-pressure source, and the suction cover slidably covers an inner circumferential wall of the disk-shaped cavity so that all the seed-suction ventilation holes except the seed-suction ventilation holes at a blowing position are located inside the suction cover.

In some embodiments, the blowing unit includes a blow pipe and a blow cover, where one end of the blow pipe longitudinally penetrates through the two sealed ends of the penetration pipe and the support unit and is connected to a positive-pressure air source, another end of the blow pipe is bent downward and connected to the blow cover, the blow cover slidably covers the communication holes at the lowest position in the disk-shaped cavity, and a friction sealing ring is provided at a lower opening of the blow cover.

In some embodiments, each hill-drop device includes a strip-shaped mounting base plate, a first rebound unit, a second rebound unit, a pressing support unit, a hole-piercing mechanism, and a seed-delivery mechanism, where the pressing support unit is mounted on the support unit and is configured to sequentially apply top-down pressing on the hole-piercing mechanism and the seed-delivery mechanism, followed by sequential release of the top-down pressing action; the strip-shaped mounting base plate is detachably mounted in a corresponding one of the hill-drop mounting holes, the hole-piercing mechanism is movably mounted through the strip-shaped mounting base plate, the first rebound unit is mounted on the strip-shaped mounting base plate and configured to elastically support the hole-piercing mechanism upward; and the seed-delivery mechanism is mounted on the strip-shaped mounting base plate and has a lower end movably extending into the hole-piercing mechanism, and the second rebound unit is mounted on the strip-shaped mounting base plate and configured to elastically support the seed-delivery mechanism upward.

In some embodiments, the pressing support unit includes a pressing support plate, two hole-piercing pressing strips, and two seed-delivery pressing strips, where the pressing support plate is horizontally fixed on a lower side of the support unit, the two hole-piercing pressing strips and the two seed-delivery pressing strips are transversely fixed on a lower side of the pressing support plate, and the two seed-delivery pressing strips are located between the two hole-piercing pressing strips, a lower end of the seed metering pipe penetrates through the pressing support plate and is located between the two seed-delivery pressing strips, left ends of the two hole-piercing pressing strips extend leftward beyond left ends of the two seed-delivery pressing strips, right ends of the two seed-delivery pressing strips extend rightward beyond right ends of the two hole-piercing pressing strips, supporting heights of the seed-delivery pressing strips are greater than supporting heights of the hole-piercing pressing strips, and supporting inclined surfaces are respectively provided at the left ends and the right ends of the two hole-piercing pressing strips and the left ends and the right ends of the two seed-delivery pressing strips.

In some embodiments, the first rebound unit includes two first rebound branches, where each first rebound branch includes a first telescopic tube, a first telescopic rod, and a first rebound spring, where the hole-piercing mechanism includes a hole-piercing square tube, a closing tension spring, two rebound support side plates, and two rectangular closing plates, where the hole-piercing square tube vertically penetrates and is movably mounted on the strip-shaped mounting base plate, front and rear sidewalls of a lower end of the hole-piercing square tube extend downward in a triangular tip shape, upper edges of the two rectangular closing plates are swingably hinged on left and right sides of the lower end of the hole-piercing square tube respectively, the closing tension spring is tensioned and arranged between the two rectangular closing plates to pull the two rectangular closing plates to press against left and right side edges of the triangular tip, the two rebound support side plates are vertically arranged on front and rear sidewalls of an upper end of the hole-piercing square tube, an upper support is provided on an outer sidewall of each rebound support side plate, an upper end of the first telescopic rod is fixed on the upper support, a lower end of the first telescopic rod is movably inserted into an upper end of the first telescopic tube, a lower end of the first telescopic tube is fixed on the strip-shaped mounting base plate, the first rebound spring is elastically supported between the upper support and the strip-shaped mounting base plate, and the first telescopic rod and the first telescopic tube are both located inside the first rebound spring.

In some embodiments, the second rebound unit includes a U-shaped bracket and two second rebound branches, where each second rebound branch includes a second telescopic rod and a second rebound spring, where the seed-delivery mechanism includes a strip-shaped collecting funnel and a seed-delivery square tube, where left and right vertical brackets of the U-shaped bracket are vertically fixed on the strip-shaped mounting base plate, a top bracket of the U-shaped bracket transversely penetrates between the two rebound support side plates, an upper end of the seed-delivery square tube is connected to a bottom of the strip-shaped collecting funnel, a lower end of the seed-delivery square tube movably penetrates through the top bracket of the U-shaped bracket and extends into the hole-piercing square tube, lower ends of the second telescopic rods of the two second rebound branches are movably vertically inserted into the left and the right vertical brackets of the U-shaped bracket respectively, upper ends of the second telescopic rods of the two second rebound branches are respectively fixed on left and right sides of the strip-shaped collecting funnel, the second rebound spring is sleeved on the second telescopic rod, and the second rebound spring is elastically supported between the strip-shaped collecting funnel and the U-shaped bracket.

Compared with the prior art, the disclosure has the beneficial effects that each hill-drop device is installed according to the required spacing by using the hill-drop mounting holes, thus meeting the requirements of seeding seeds with different spacing. The seed metering mechanism may be used for seeding, and then when the hill-drop device passes from the lower side, the seeds are delivered to the hill-drop device, and the hill-drop device is pushed to sow downwards, so that the seeds may be accurately delivered to the soil under the film, and the precision and reliability of sowing are ensured.

### BRIEF DESCRIPTION OF THE DRAWINGS

FIG. 1 is a schematic view of an overall structure of a system of the disclosure.

FIG. 2 is a cross-sectional structural view of the system of the disclosure.

FIG. 3 is a partially cross-sectional structural view of a seed metering mechanism and a hill-drop device of the disclosure.

FIG. 4 is an installation structural view of the seed metering mechanism and the hill-drop device of the disclosure.

FIG. 5 is a structural view of the hill-drop device of the present disclosure in three states.

FIG. 6 is a structural view of the hill-drop device of the present disclosure in a non-pressed state.

FIG. 7 is a structural view of the hill-drop device of the present disclosure in a pressed state.

FIG. 8 is a partially cross-sectional structural view of the system of the disclosure.

FIG. 9 is a cross-sectional structural view of the seed metering mechanism of the disclosure.

### DETAILED DESCRIPTION OF THE EMBODIMENT

The technical scheme of the present disclosure is described in detail below with reference to the drawings. However, the scope of protection of the present disclosure is not limited to the described embodiment.

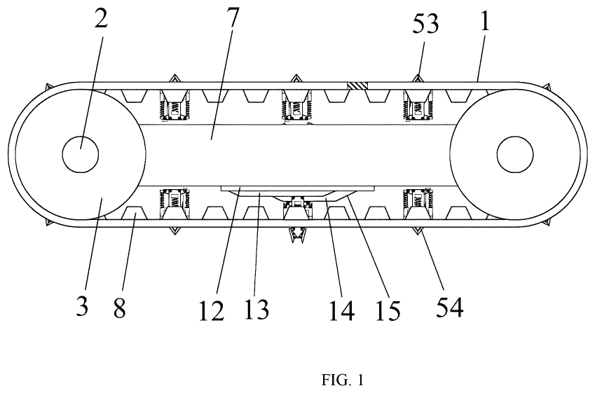

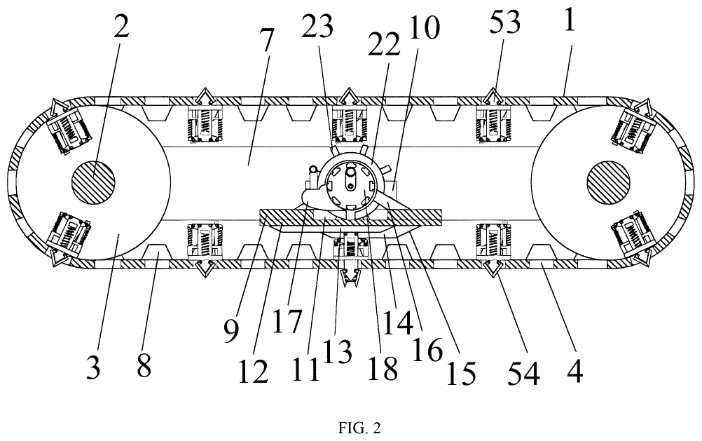

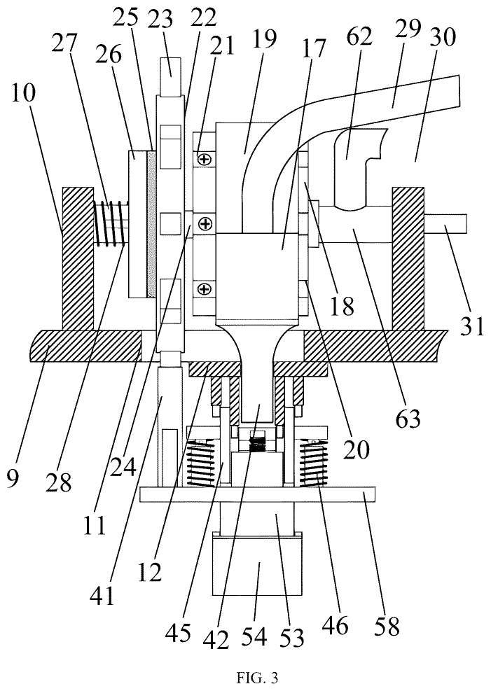

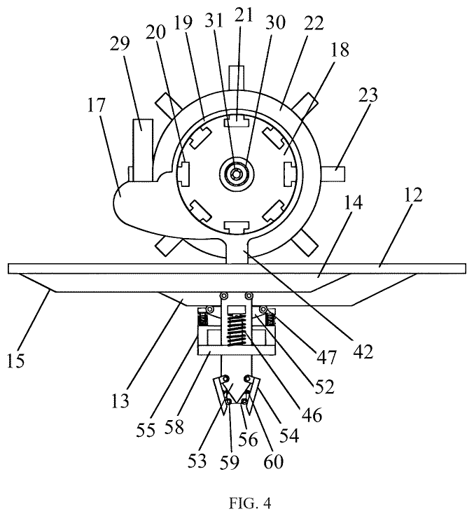

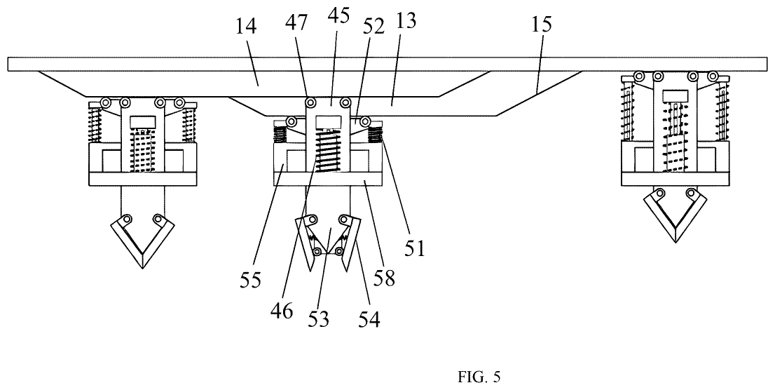

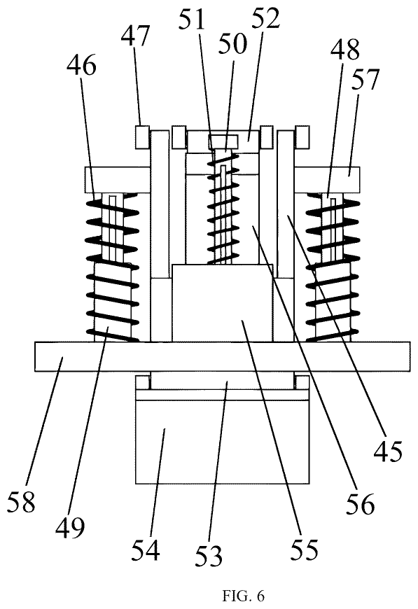

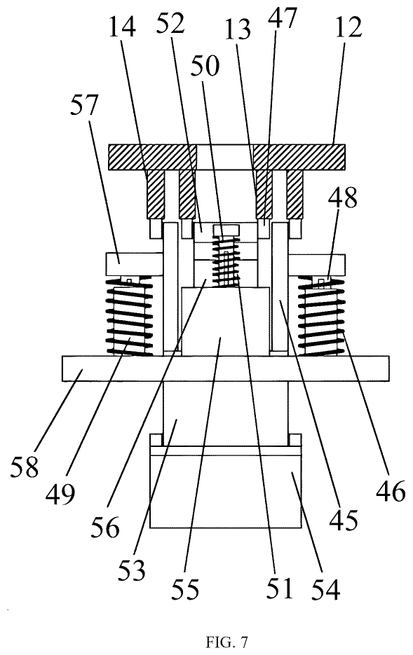

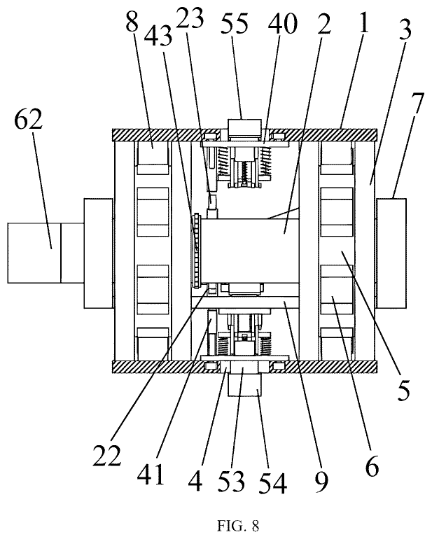

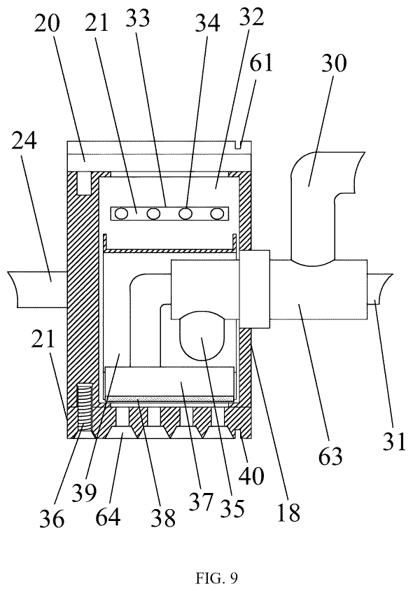

As shown in FIGS. 1-9, the high-speed seeding system disclosed in the present disclosure includes a crawler mechanism, a seed metering mechanism, and multiple hill-drop devices, where the crawler mechanism includes a motor drive unit, transmission crawler belts 1, and a crawler support unit, where the transmission crawler belts 1 are provided with multiple hill-drop mounting holes 4 at intervals, the crawler support unit is configured to support and drive the transmission crawler belts 1, the motor drive unit is configured to drive the transmission crawler belts 1 through the crawler support unit, the hill-drop devices are respectively mounted in the corresponding hill-drop mounting holes 4 according to seeding spacing, and the seed metering mechanism is fixed on the crawler support unit and is configured to deliver seeds to the hill-drop devices when the hill-drop devices pass underneath and to push the hill-drop devices downward for seeding.

Each hill-drop device is installed according to the required spacing by using the hill-drop mounting holes 4, thus meeting the requirements of seeding seeds with different spacing. The seed metering mechanism may be used for seeding, and then when the hill-drop device passes from the lower side, the seeds are delivered to the hill-drop device, and the hill-drop device is pushed to sow downwards, so that the seeds may be accurately delivered to the soil under the film, and the precision and reliability of sowing are ensured.

In this embodiment, the crawler support unit includes four support rollers 3, two roller shafts 2, and two strip-shaped support plates 7, where the motor drive unit includes a drive motor 62 and a sprocket transmission assembly 43, where the two roller shafts 2 are rotatably mounted between the respective ends of the two strip-shaped support plates 7, the four support rollers 3 are fixed in pairs on the two roller shafts 2, a clearance for allowing passage of the hill-drop devices is formed between the two support rollers 3 on the same roller shaft 2, the drive motor 62 is fixed on the strip-shaped support plates 7 and drive one of the roller shafts 2 to rotate through the sprocket transmission assembly 43, drive annular grooves 5 are arranged on wheel surfaces of the support rollers 3, drive teeth 6 are provided in the drive annular grooves 5, the transmission crawler belts 1 are wound around the four support rollers 3, and driven teeth 8 meshing with the drive teeth 6 are provided on inner sides of the transmission crawler belts 1. With the cooperation of the drive annular groove 5 and the driven teeth 8, the spacing between the support roller 3 and the transmission crawler belts 1 may be realized, and the support roller 3 may be prevented from being separated from the transmission crawler belts 1. With the cooperation of the drive teeth 6 and the driven teeth 8, the support roller 3 may drive the transmission crawler belts 1.

In this embodiment, the seed metering mechanism includes a support unit, a friction unit, a rotary drive disk 22, a seed metering disk 18, an outer housing 19, a suction unit, a blowing unit, and multiple seed-suction inserts 21, where a disk-shaped cavity 32 is formed inside the seed metering disk 18, a support short shaft 24 is fixed at a center of a rear disk surface of the seed metering disk 18, an end of the support short shaft 24 is rotatably mounted on the support unit, the rotary drive disk 22 is fixed on the support short shaft 24 and is rotated by being pushed by the hill-drop devices passing underneath, the friction unit is mounted on the support unit and provides frictional damping to the rotary drive disk 22, multiple T-shaped slots 20 are longitudinally arranged at intervals on an outer circumferential surface of the seed metering disk 18, and the seed-suction inserts 21 are longitudinally inserted into the T-shaped slots 20 along the axial direction of the rotary drive disk 22, and are fixedly installed by locking bolts 36. Multiple seed-suction ventilation holes 34 are arranged on the seed-suction inserts 21, outer openings of the seed-suction ventilation holes 34 are configured as conical slopes 64, communication holes 33 connected to the seed-suction ventilation holes 34 are provided on a wall of the disk-shaped cavity 32, the outer housing 19 covers the outer circumferential surface of the seed metering disk 18 and is fixed on the support unit, a seed storage bin 17 is provided at a lower left side of the outer housing 19, and a seed delivery pipe 29 is connected to a top of the seed storage bin 17. A brush is arranged at the upper part of the seed storage bin 17 near the seed metering disk 18, which is used to sweep excess seeds from the conical slope 64. A seed metering pipe 42 is vertically arranged at a lower part of the outer housing 19 for delivering the seeds to the hill-drop devices below, the blowing unit penetrates through a center of a front disk surface of the seed metering disk 18 and blows air into the communication holes 33 at a lowest position in the disk-shaped cavity 32 to blow seeds adsorbed on the seed-suction ventilation holes 34 at the lowest position into the seed metering pipe 42, and the suction unit penetrates through the center of the front disk surface of the seed metering disk 18 and sucks air from the communication holes 33 at other positions in the disk-shaped cavity 32 to adsorb the seeds onto the seed-suction ventilation holes 34 at the other positions. The friction unit may be used to perform frictional damping on the rotary drive disk 22, so that the rotary drive disk 22 may stop rotating in time when it is not pushed, and the inertia effect may be reduced. The T-shaped slot 20 may be used to detachably install the seed-suction inserts 21, so that the seed-suction inserts 21 with different numbers of seed-suction ventilation holes 34 may be replaced according to the sowing needs, and the sowing number of each hole position may be changed. The blowing unit may be used, the seeds adsorbed on the lowermost seed-suction ventilation holes 34 may be blown into the seed metering pipe 42, and an acceleration is given to each seed, so that the seeds may quickly fall into the seed hole. The seeds in the seed storage bin 17 may be firmly adsorbed to the conical slope 64 by the suction unit for transportation.

In this embodiment, multiple driven push rods 23 are arranged at intervals on the circumference of the rotary drive disk 22. A drive push rod 41 is vertically installed on the strip-shaped mounting base plate 58 of each hill-drop device to push the driven push rods 23 when hill-drop device passes, rotating the rotary drive disk 22 by one seed metering angle. The rotary drive disk 22 is rotated by the drive push rod 41 on each hill-drop device, thus realizing passive trigger seeding, and it is not necessary to change the seed metering frequency of the seed metering mechanism separately when changing the spacing of the hill-drop devices.

In this embodiment, an outer limiting groove 61 is formed on the outer circumferential surface of the seed metering disk 18. An end limiting groove 40 is arranged on the seed-suction inserts 21, and a groove for a limit ring is formed by the outer limiting groove 61 and the end limiting groove 40. The outer housing 19 is provided with various limit lugs which are slidably embedded in the limit ring groove, and the limit lugs are arranged at intervals, so that the seed-suction inserts 21 may be easily replaced for avoidance and the seed-suction inserts 21 may be smoothly pulled out. By using the matching arrangement of the limit ring groove and the limit convex ring, the stable rotary installation between the outer housing 19 and the seed metering disk 18 may be realized.

In this embodiment, the support unit includes a support mounting base plate 9 and two support side plates 10. The support mounting base plate 9 is longitudinally fixed on the lower edges of the two strip-shaped support plates 7. The two support side plates 10 are vertically fixed on the upper surface of the support mounting base plate 9. In the middle of the support mounting base plate 9, there is a clearance hole 11 for avoiding the rotary drive disk 22 and the outer housing 19. The end of the support short shaft 24 is rotatably mounted on the support side plate 10. The support sleeve 27 is fixed on the support side plate 10. The penetration pipe 63 is fixed on the support side plate 10. The outer housing 19 is supported on the support mounting base plate (9) by inclined struts 16.

In this embodiment, the friction unit includes a support sleeve 27, a support disk 26, a friction spring 28, and a friction plate 25, where one end of the support sleeve 27 is fixed on the support unit, the support disk 26 is axially slidably mounted on a cantilevered end of the support sleeve 27, the friction spring 28 is sleeved on the support sleeve 27 and elastically supports between the support unit and the support disk 26, the friction plate 25 is fixed on the support disk 26 and presses against the rotary drive disk 22 under support of the friction spring 28, the support short shaft 24 penetrates through the friction plate 25, the support disk 26, and the support sleeve 27 and is rotatably mounted on the support unit, a rotation-limiting chute is arranged on an outer wall of the support sleeve 27 along length direction of the support sleeve, and a rotation-limiting slider slidably embedded in the rotation-limiting chute is provided on the support disk 26. The friction spring 28 may elastically press the support disk 26 and the friction plate 25, so that the rotary drive disk 22 always maintains a good frictional damping effect.

In this embodiment, the suction unit includes a suction cover 39, a suction pipe 35, a penetration pipe 63, and a negative-pressure connection pipe 30, where one end of the penetration pipe 63 is fixed on the support unit, another end rotatably penetrates through the center of the front disk surface of the seed metering disk 18, two ends of the penetration pipe 63 are sealed, one end of the suction pipe 35 is connected to an inner sealed end side of the penetration pipe 63, one end of the negative-pressure connection pipe 30 is connected to an outer sealed end side of the penetration pipe 63, another end of the suction pipe 35 is connected to the suction cover 39, another end of the negative-pressure connection pipe 30 is connected to a negative-pressure source, and the suction cover 39 slidably covers an inner circumferential wall of the disk-shaped cavity 32 so that all the seed-suction ventilation holes 34 except the seed-suction ventilation holes 34 at a blowing position are located inside the suction cover 39. The suction cover 39 may enhance the suction effect on each seed-suction ventilation hole 34.

In this embodiment, the blowing unit includes a blow pipe 31 and a blow cover 37, where one end of the blow pipe 31 longitudinally penetrates through the two sealed ends of the penetration pipe 63 and the support unit and is connected to a positive-pressure air source, another end of the blow pipe 31 is bent downward and connected to the blow cover 37, the blow cover 37 slidably covers the communication holes 33 at the lowest position in the disk-shaped cavity 32, and a friction sealing ring 38 is provided at a lower opening of the blow cover 37. The friction sealing ring 38 may enhance the air tightness of the blow cover 37 and ensure the blowing effect on the communication hole 33.

In this embodiment, each hill-drop device includes a strip-shaped mounting base plate 58, a first rebound unit, a second rebound unit, a pressing support unit, a hole-piercing mechanism, and a seed-delivery mechanism, where the pressing support unit is mounted on the support unit and is configured to sequentially apply top-down pressing on the hole-piercing mechanism and the seed-delivery mechanism, followed by sequential release of the top-down pressing action; the strip-shaped mounting base plate 58 is detachably mounted in the respective hill-drop mounting hole 4, the hole-piercing mechanism is movably mounted through the strip-shaped mounting base plate 58, the first rebound unit is mounted on the strip-shaped mounting base plate 58 and elastically supports the hole-piercing mechanism upward; and the seed-delivery mechanism is mounted on the strip-shaped mounting base plate 58 and has a lower end movably extending into the hole-piercing mechanism, and the second rebound unit is mounted on the strip-shaped mounting base plate 58 and elastically supports the seed-delivery mechanism upward. The first rebound unit and the second rebound unit may respectively elastically support the hole-piercing mechanism and the seed-delivery mechanism, so as to rebound in time after being pressed by the pressing support unit. By utilizing the pressing support unit, when the hole-piercing mechanism and seed-delivery mechanism pass beneath it, the unit sequentially applies top-down pressing on the hole-piercing mechanism first, followed by the seed-delivery mechanism, and then releases the pressing action in the same order. This sequential operation ensures that the hole-piercing mechanism lifts first, then the seed-delivery mechanism lifts afterward. As a result, seeds are effectively buried in the soil beneath the film without being displaced from the soil or bouncing onto the film surface.

In this embodiment, the pressing support unit includes a pressing support plate 12, two hole-piercing pressing strips 14, and two seed-delivery pressing strips 13, where the pressing support plate 12 is horizontally fixed on a lower side of the support unit, the two hole-piercing pressing strips 14 and the two seed-delivery pressing strips 13 are transversely fixed on a lower side of the pressing support plate 12, the two seed-delivery pressing strips 13 are located between the two hole-piercing pressing strips 14, a lower end of the seed metering pipe 42 penetrates through the pressing support plate 12 and is located between the two seed-delivery pressing strips 13, left ends of the two hole-piercing pressing strips 14 extend leftward beyond left ends of the two seed-delivery pressing strips 13, right ends of the two seed-delivery pressing strips 13 extend rightward beyond right ends of the two hole-piercing pressing strips 14, supporting heights of the seed-delivery pressing strips 13 are greater than supporting heights of the hole-piercing pressing strips 14, and supporting inclined surfaces 15 are provided at the left and the right ends of the two hole-piercing pressing strips 14 and the left and the right ends of the two seed-delivery pressing strips 13, so that the hole-piercing mechanism and the seed-delivery mechanism may conveniently be pressed and released by the hole-piercing pressing strips 14 and the seed-delivery pressing strips 13. With the structural design of the two hole-piercing pressing strips 14 and the two seed-delivery pressing strips 13, the hole-piercing mechanism and the seed-delivery mechanism may be pressed down at the top first, and then the top pressing is released successively.

In this embodiment, the first rebound unit includes two first rebound branches, where each first rebound branch includes a first telescopic tube 49, a first telescopic rod 48, and a first rebound spring 46, where the hole-piercing mechanism includes a hole-piercing square tube 53, a closing tension spring 60, two rebound support side plates 45, and two rectangular closing plates 54, where the hole-piercing square tube 53 vertically penetrates and is movably mounted on the strip-shaped mounting base plate 58, front and rear sidewalls of a lower end of the hole-piercing square tube 53 extend downward in a triangular tip shape, upper edges of the two rectangular closing plates 54 are swingably hinged on left and right sides of the lower end of the hole-piercing square tube 53 respectively, the closing tension spring 60 is tensioned and arranged between the two rectangular closing plates 54 to pull the two rectangular closing plates 54 to press against left and right side edges of the triangular tip, the two rebound support side plates 45 are vertically arranged on front and rear sidewalls of an upper end of the hole-piercing square tube 53, an upper support 57 is provided on an outer sidewall of each rebound support side plate 45, an upper end of the first telescopic rod 48 is fixed on the upper support 57, a lower end of the first telescopic rod 48 is movably inserted into an upper end of the first telescopic tube 49, a lower end of the first telescopic tube 49 is fixed on the strip-shaped mounting base plate 58, the first rebound spring 46 is elastically supported between the upper support 57 and the strip-shaped mounting base plate 58, and the first telescopic rod 48 and the first telescopic tube 49 are both located inside the first rebound spring 46. The two rectangular closing plates 54 may be pulled by the closing tension spring 60, so that the two rectangular closing plates 54 are pressed on the left and right sides of the triangular tip respectively, forming a hole-piercing tip for piercing the film and inserting the soil.

In this embodiment, a top-corner support wheel 47 is rotatably installed at each upper corner of the left and right sides of the two rebound support side plates 45, enabling rolling support when passing the two hole-piercing pressing strips 14.

In this embodiment, a first limiting chute is vertically formed on the first telescopic rod 48, and a first limiting slider slidably embedded in the first limiting chute is provided on the inner wall of the first telescopic tube 49, restricting the telescopic range of the first telescopic rod 48.

In this embodiment, the second rebound unit includes a U-shaped bracket 55 and two second rebound branches, where each second rebound branch includes a second telescopic rod 50 and a second rebound spring 51, where the seed-delivery mechanism includes a strip-shaped collecting funnel 52 and a seed-delivery square tube 56, where left and right vertical brackets of the U-shaped bracket 55 are vertically fixed on the strip-shaped mounting base plate 58, a top bracket of the U-shaped bracket 55 transversely penetrates between the two rebound support side plates 45, an upper end of the seed-delivery square tube 56 is connected to a bottom of the strip-shaped collecting funnel 52, a lower end of the seed-delivery square tube 56 movably penetrates through the top bracket of the U-shaped bracket 55 and extends into the hole-piercing square tube 53, lower ends of the second telescopic rods 50 of the two second rebound branches are movably vertically inserted into the left and the right vertical brackets of the U-shaped bracket 55 respectively, upper ends of the second telescopic rods 50 of the two second rebound branches are respectively fixed on left and right sides of the strip-shaped collecting funnel 52, the second rebound spring 51 is sleeved on the second telescopic rod 50, and the second rebound spring 51 is elastically supported between the strip-shaped collecting funnel 52 and the U-shaped bracket 55. The utilization of the strip-shaped collecting funnel 52 may facilitate receiving the seeds blown by the seed metering pipe 42. The seed-delivery square tube 56 is inserted into the hole-piercing square tube 53, so that when the seed-delivery pressing strip 13 is pressed down, two rectangular closing plates 54 are opened by the lower end of the seed-delivery square tube 56, so that the seeds may smoothly enter and fall into the seed hole, and then the hole-piercing square tube 53 is supported by the first rebound unit to rise, and the rectangular closing plates 54 synchronously rise away from the seeds. At this time, the soil backfill surrounds the lower end of the seed-delivery square tube 56, and then the seed-delivery square tube 56 is supported by the second rebound unit to rise. The seeds are enclosed by the soil and stay in the soil, and will not be taken out of the soil or film by the rectangular closing plate 54 or the seed-delivery square tube 56.

In this embodiment, the top-corner support wheel 47 is rotatably installed at each upper corner of the left and right sides of the strip-shaped collecting funnel 52, enabling rolling support when passing the two seed-delivery pressing strips 13. A bottom-corner support wheel 59 is rotatably installed at each lower corner of the left and right sides of the seed-delivery square tube 56, so as to provide rolling support when contacting with the rectangular closing plate 54.

In this embodiment, a second limiting chute is vertically arranged on the outer wall of the second telescopic rod 50, and a second limiting slider slidably embedded in the second limiting chute is arranged on the U-shaped bracket 55, thereby limiting the telescopic range of the second telescopic rod 50.

As described above, although the present disclosure has been illustrated and described with reference to the specific optional embodiment, this should not be construed as limiting the disclosure itself. Without departing from the spirit and scope of the disclosure as defined by the appended claims, various modifications may be made in form and detail.

What is claimed is:

1. A high-speed seeding system, comprising: a crawler mechanism, a seed metering mechanism, and a plurality of hill-drop devices; wherein the crawler mechanism comprises a motor drive unit, transmission crawler belts, and a crawler support unit, the transmission crawler belts are provided with a plurality of hill-drop mounting holes at intervals, the crawler support unit is configured to support and drive the transmission crawler belts, the motor drive unit is configured to drive the transmission crawler belts through the crawler support unit, the hill-drop devices are respectively mounted in the hill-drop mounting holes according to seeding intervals, and the seed metering mechanism is fixed on the crawler support unit and is configured to deliver seeds to the hill-drop devices and push the hill-drop devices downward for seeding when the hill-drop devices pass underneath the seed metering mechanism.

2. The high-speed seeding system according to claim 1, wherein the crawler support unit comprises four support rollers, two roller shafts, and two strip-shaped support plates, the motor drive unit comprises a drive motor and a sprocket transmission assembly, the two roller shafts are rotatably mounted between respective ends of the two strip-shaped support plates, the four support rollers are respectively fixed on ends of the two roller shafts, a clearance is formed between two of the four support rollers on a same roller shaft for allowing passage of the hill-drop devices, the drive motor is fixed on the two strip-shaped support plates and configured to drive one of the two roller shafts to rotate through the sprocket transmission assembly, drive annular grooves are arranged on wheel surfaces of the four support rollers, drive teeth are provided in the drive annular grooves, the transmission crawler belts are wound around the four support rollers, and driven teeth meshing with the drive teeth are provided on inner sides of the transmission crawler belts.

3. The high-speed seeding system according to claim 1, wherein the seed metering mechanism comprises a support unit, a friction unit, a rotary drive disk, a seed metering disk, an outer housing, a suction unit, a blowing unit, and a plurality of seed-suction inserts, a disk-shaped cavity is formed inside the seed metering disk, a support short shaft is fixed at a center of a rear disk surface of the seed metering disk, an end of the support short shaft is rotatably mounted on the support unit, the rotary drive disk is fixed on the support short shaft and is rotated by being pushed by the hill-drop devices passing underneath, the friction unit is mounted on the support unit and provides frictional damping to the rotary drive disk, a plurality of T-shaped slots are circumferentially arranged at intervals on an outer surface of the seed metering disk, the seed-suction inserts are respectively inserted into the T-shaped slots along a axial direction of the rotary drive disk, a plurality of seed-suction ventilation holes are arranged on the seed-suction inserts, outer openings of the seed-suction ventilation holes are configured as conical slopes, communication holes in communication with the seed-suction ventilation holes are provided on a wall of the disk-shaped cavity, the outer housing covers the outer surface of the seed metering disk and is fixed on the support unit, a seed storage bin is provided at a lower left side of the outer housing, a seed delivery pipe is connected to a top of the seed storage bin, a seed metering pipe is vertically arranged at a lower part of the outer housing for delivering the seeds to the hill-drop devices below, the blowing unit penetrates through a center of a front disk surface of the seed metering disk and blows air into the communication holes at a lowest position in the disk-shaped cavity to blow the seeds adsorbed on the seed-suction ventilation holes at the lowest position into the seed metering pipe, and the suction unit penetrates through the center of the front disk surface of the seed metering disk and is configured to suck air from the communication holes at other positions in the disk-shaped cavity to adsorb the seeds onto the seed-suction ventilation holes at the other positions.

4. The high-speed seeding system according to claim 3, wherein the friction unit comprises a support sleeve, a support disk, a friction spring, and a friction plate, one end of the support sleeve is fixed on the support unit, the support disk is axially slidably mounted on a cantilevered end of the support sleeve, the friction spring is sleeved on the support sleeve and elastically supports between the support unit and the support disk, the friction plate is fixed on the support disk and configured to presses against the rotary drive disk under support of the friction spring, the support short shaft penetrates through the friction plate, the support disk, and the support sleeve and is rotatably mounted on the support unit, a rotation-limiting chute is arranged on an outer wall of the support sleeve along a length direction of the support sleeve, and a rotation-limiting slider slidably embedded in the rotation-limiting chute is provided on the support disk.

5. The high-speed seeding system according to claim 3, wherein the suction unit comprises a suction cover, a suction pipe, a penetration pipe, and a negative-pressure connection pipe, one end of the penetration pipe is fixed on the support unit, another end rotatably penetrates through the center of the front disk surface of the seed metering disk, two ends of the penetration pipe are sealed, one end of the suction pipe is connected to an inner sealed end side of the penetration pipe, one end of the negative-pressure connection pipe is connected to an outer sealed end side of the penetration pipe, another end of the suction pipe is connected to the suction cover, another end of the negative-pressure connection pipe is connected to a negative-pressure source, and the suction cover slidably covers an inner circumferential wall of the disk-shaped cavity so that all the seed-suction ventilation holes except the seed-suction ventilation holes at a blowing position are located inside the suction cover.

6. The high-speed seeding system according to claim 5, wherein the blowing unit comprises a blow pipe and a blow cover, one end of the blow pipe longitudinally penetrates through the inner sealed end and the outer sealed end of the penetration pipe and the support unit and is connected to a positive-pressure air source, another end of the blow pipe is bent downward and connected to the blow cover, the blow cover slidably covers the communication holes at the lowest position in the disk-shaped cavity, and a friction sealing ring is provided at a lower opening of the blow cover.

7. The high-speed seeding system according to claim 3, wherein each of the plurality of hill-drop devices comprises a strip-shaped mounting base plate, a first rebound unit, a second rebound unit, a pressing support unit, a hole-piercing mechanism, and a seed-delivery mechanism, the pressing support unit is mounted on the support unit and is configured to sequentially apply top-down pressing on the hole-piercing mechanism and the seed-delivery mechanism, followed by sequential release of the top-down pressing action, the strip-shaped mounting base plate is detachably mounted in a corresponding one of the hill-drop mounting holes, the hole-piercing mechanism is movably mounted through the strip-shaped mounting base plate, the first rebound unit is mounted on the strip-shaped mounting base plate and configured to elastically support the hole-piercing mechanism upward, the seed-delivery mechanism is mounted on the strip-shaped mounting base plate and has a lower end movably extending into the hole-piercing mechanism, and the second rebound unit is mounted on the strip-shaped mounting base plate and configured to elastically support the seed-delivery mechanism upward.

8. The high-speed seeding system according to claim 7, wherein the pressing support unit comprises a pressing support plate, two hole-piercing pressing strips, and two seed-delivery pressing strips, the pressing support plate is horizontally fixed on a lower side of the support unit, the two hole-piercing pressing strips and the two seed-delivery pressing strips are transversely fixed on a lower side of the pressing support plate, the two seed-delivery pressing strips are located between the two hole-piercing pressing strips, a lower end of the seed metering pipe penetrates through the pressing support plate and is located between the two seed-delivery pressing strips, left ends of the two hole-piercing pressing strips extend leftward beyond left ends of the two seed-delivery pressing strips, right ends of the two seed-delivery pressing strips extend rightward beyond right ends of the two hole-piercing pressing strips, supporting heights of the two seed-delivery pressing strips are greater than supporting heights of the two hole-piercing pressing strips, and supporting inclined surfaces are respectively provided at the left ends and the right ends of the two hole-piercing pressing strips and the left ends and the right ends of the two seed-delivery pressing strips.

9. The high-speed seeding system according to claim 7, wherein the first rebound unit comprises two first rebound branches, each of the two first rebound branches comprises a first telescopic tube, a first telescopic rod, and a first rebound spring, the hole-piercing mechanism comprises a hole-piercing square tube, a closing tension spring, two rebound support side plates, and two rectangular closing plates, the hole-piercing square tube vertically penetrates and is movably mounted on the strip-shaped mounting base plate, front and rear sidewalls of a lower end of the hole-piercing square tube extend downward in a triangular tip shape, upper edges of the two rectangular closing plates are swingably hinged on left and right sides of the lower end of the hole-piercing square tube respectively, the closing tension spring is tensioned and arranged between the two rectangular closing plates to pull the two rectangular closing plates to press against left and right side edges of the triangular tip, the two rebound support side plates are vertically arranged on front and rear sidewalls of an upper end of the hole-piercing square tube, an upper support is provided on an outer sidewall of each rebound support side plate, an upper end of the first telescopic rod is fixed on the upper support, a lower end of the first telescopic rod is movably inserted into an upper end of the first telescopic tube, a lower end of the first telescopic tube is fixed on the strip-shaped mounting base plate, the first rebound spring is elastically supported between the upper support and the strip-shaped mounting base plate, and the first telescopic rod and the first telescopic tube are both located inside the first rebound spring.

10. The high-speed seeding system according to claim 9, wherein the second rebound unit comprises a U-shaped bracket and two second rebound branches, each of the two second rebound branches comprises a second telescopic rod and a second rebound spring, the seed-delivery mechanism comprises a strip-shaped collecting funnel and a seed-delivery square tube, left and right vertical brackets of the U-shaped bracket are vertically fixed on the strip-shaped mounting base plate, a top bracket of the U-shaped bracket transversely penetrates between the two rebound support side plates, an upper end of the seed-delivery square tube is connected to a bottom of the strip-shaped collecting funnel, a lower end of the seed-delivery square tube movably penetrates through the top bracket of the U-shaped bracket and extends into the hole-piercing square tube, lower ends of the second telescopic rods of the two second rebound branches are movably vertically inserted into the left and the right vertical brackets of the U-shaped bracket respectively, upper ends of the second telescopic rods of the two second rebound branches are respectively fixed on left and right sides of the strip-shaped collecting funnel, the second rebound spring is sleeved on the second telescopic rod, and the second rebound spring is elastically supported between the strip-shaped collecting funnel and the U-shaped bracket.
